(19) United States
(12) Patent Application Publication
(10) Pub. No.: US 2017/0292092 A1
(43) Pub. Date: Oct. 12, 2017

(54) LIQUID ACIDIC HARD SURFACE CLEANING COMPOSITIONS HAVING IMPROVED SHINE

(71) Applicant: The Procter & Gamble Company, 15481488, OH (US)

(72) Inventors: Anna ASMANIDOU, Brussels (BE); Gloria DI CAPUA, Ardea (IT); Aaron FLORES-FIGUEROA, Mannheim (DE); Frank HULSKOTTER, Schwalbach am Taunus (DE); Martin RUEBENACKER, Altrip (DE); Stefano SCIALLA, Rome (IT); James Robert TINLIN, Brussels (BE)

(21) Appl. No.: 15/481,488

(22) Filed: Apr. 7, 2017

(30) Foreign Application Priority Data
Apr. 8, 2016 (EP) 16 164 580.9

(51) Int. Cl. C11D 3/37; C11D 3/20; C11D 3/04; C11D 11/00

(52) U.S. Cl. CPC C11D 3/3776; C11D 11/0023; C11D 3/2086; C11D 3/2079; C11D 3/044

(57) ABSTRACT

Liquid acidic hard surface cleaning composition comprising certain copolymers provide good limescale removal and long lasting shine to a broad range of surfaces. Moreover, when formulated with suitable acid systems, they also provide improved surface safety over more delicate surfaces.

### TECHNICAL FIELD

The present invention relates to acidic liquid compositions for cleaning a variety of hard surfaces such as hard surfaces found in around the house, such as bathrooms, toilets, garages, driveways, basements, gardens, kitchens, etc. More specifically, the compositions of the present invention deliver good limescale removal performance (i.e., removal of pure limescale deposits and/or limescale-containing soils) and good shine, whilst having a good surface safety profile on the treated surface.

### BACKGROUND OF THE INVENTION

Liquid compositions for cleaning limescale from hard-surfaces have been disclosed in the art. Limescale deposits, are formed due to the fact that tap water contains a certain amount of solubilised ions, which upon water evaporation eventually deposit as salts such as calcium carbonate on hard surfaces, which are frequently in contact with water. The visible limescale deposits result in an unaesthetic aspect of the surfaces. The limescale formation and deposition phenomenon is even more acute in places where water is particularly hard. Furthermore, limescale deposits are prone to combination with other types of soils, such as soap scum or grease, and can lead to the formation of limescale-soil mixture deposits (limescale-containing soils). The removal of limescale deposits and limescale-containing soils is herein in general referred to as “limescale removal” or “removing limescale”.

Films and streaks may be left which results in poor shine, and an impression that the surface is not yet sufficiently clean. Surface active polymers, such as polyvinylpyrrolidone and polycarboxylates have been formulated into acidic cleaners to improve shine on ceramic surfaces. However, such polymers have been found to be less effective on other surfaces, especially those found in kitchens and the like.

More delicate materials are also often found in kitchens than the ceramics that are typically found in bathrooms and the like. Such surfaces include polymers, including formica™, vinyl, melamine, and other polymeric materials, in addition to stainless steels, glass, brass, and other metals. Hence, it is desirable to formulate the acid hard surface cleaning compositions which are suitable for such surfaces, while also leaving the surfaces pleasantly shiny.

In addition, surface active polymers can be challenging to formulate stably into acidic compositions.

As such, a need remains for stable hard surface cleaning compositions which are more suitable for removing limescale from kitchen surfaces, especially where grease stains are present, while also providing long lasting shine.

WO 2004/018599 describes acidic hard surface cleaning compositions comprising an acid or a mixture thereof. EP0666306 A1 and EP0666305 A1 describe liquid compositions suitable for removing limescale from hard surfaces comprising maleic acid in combination with a second acid. EP2206766 A1 relates to a liquid acidic hard surface cleaning composition having a pH of from 2 to 2.9 and comprising formic acid and an alkaline material. WO2005/052107 relates to laundry compositions having copolymers containing polyalkylene oxide groups and quanternary nitrogen atoms and a surfactant system.

### SUMMARY OF THE INVENTION

The present invention relates to a liquid acidic hard surface cleaning composition having a pH of from 0.1 to 6.5 and comprising a copolymer, as described in claim 1. The present invention further relates to a method of reducing the drying time of treated hard surfaces. The present invention further relates to the use of the copolymer for reducing the drying time of treated hard surfaces.

### DETAILED DESCRIPTION OF THE INVENTION

The present compositions provide good limescale removal and long lasting shine over a wide range of surfaces. When formulated with the preferred acid systems, the acidic cleaning compositions provide good cleaning and long lasting shine, with little or no damage to delicate surfaces.

The Liquid Acidic Hard Surface Cleaning Composition

The compositions according to the present invention are designed as hard surfaces cleaners. The compositions according to the present invention are liquid compositions (including gels) as opposed to a solid or a gas.

The liquid acidic hard surface cleaning compositions according to the present invention are preferably aqueous compositions. Therefore, they may comprise from 70% to 99% by weight of the total composition of water, preferably from 75% to 95% and more preferably from 80% to 95%.

The liquid compositions of the present invention are acidic. Therefore they have a pH of less than 7. Preferably, the composition has a pH of from 1 to 6, more preferably from 2.0 to 2.5, still more preferably from 2.1 to 2.5, and most preferably from 2.1 to 2.4. The pH of the cleaning compositions is measured at 25° C.

Thus, the compositions comprise an acid system. Typically, the acid system may comprise any organic or inorganic acid well-known to those skilled in the art, or a mixture thereof. In preferred embodiments, the acid system comprises acids selected from the group consisting of: citric acid, formic acid, acetic acid, maleic acid, lactic acid, glycolic acid, succinic acid, glutaric acid, adipic acid, sulphamic acid, sulphuric acid, hydrochloric acid, phosphoric acid, nitric acid, methane sulphonic acid, and mixtures thereof, preferably acids selected from the group consisting of: citric acid, formic acid, acetic acid, lactic acid, phosphoric acid, and mixtures thereof.

The composition preferably comprises the acid system at a level of from 0.01% to 15%, preferably from 0.5% to 10%, more preferably from 2% to 8%, most preferably from 4% to 7.5% by weight of the total composition.

Formic acid has been found to provide excellent limescale removal performance, in combination with improved surface safety, especially for surfaces which are prone to corrosion. For improved surface safety, especially of more delicate surfaces, the composition preferably comprises formic acid as part of the acid system. In order to achieve the desired pH, the compositions of the present invention may comprise from 0.01% to 15%, preferably from 0.5% to 10%, more preferably from 1% to 8%, even more preferably from 1% to 6%, still more preferably 1% to 4%, yet more preferably 1% to 3%, yet still more preferably 2% to 3% by weight of the total composition of formic acid.

Lactic acid can be used as part of the acid system, especially where antimicrobial or disinfecting benefits are desired. Such compositions may comprise up to 10% by weight of the total composition of lactic acid, preferably from 0.1% to 6%, more preferably from 0.2% to 4%, even more preferably from 0.2% to 3%, and most preferably from 0.5% to 2%.

The compositions of the present invention may comprise from 0.1 to 30%, preferably from 2% to 20%, more preferably from 3% to 15%, most preferably from 3% to 10% by weight of the total composition of acetic acid. In an alternative embodiment herein, the compositions of the present invention may comprise from 0.1 to 5%, preferably from 0.1% to 3%, more preferably from 0.1% to 2%, most preferably from 0.5% to 2% by weight of the total composition of acetic acid.

The compositions of the present invention may comprise from 0.1 to 30%, preferably from 1% to 20%, more preferably from 1.5% to 15%, most preferably from 2% to 10% by weight of the total composition of citric acid.

The compositions herein can comprise an alkaline material. The alkaline material may be present to trim the pH and/or maintain the pH of the compositions according to the present invention. Examples of alkaline material are sodium hydroxide, potassium hydroxide and/or lithium hydroxide, and/or the alkali metal oxides such, as sodium and/or potassium oxide or mixtures thereof and/or monoethanolamine and/or triethanolamine Other suitable bases include ammonia, ammonium carbonate, choline base, etc. Preferably, source of alkalinity is sodium hydroxide or potassium hydroxide, preferably sodium hydroxide.

Typically the amount of alkaline material is of from 0.001% to 20% by weight, preferably from 0.01% to 10% and more preferably from 0.05% to 3% by weight of the composition.

Despite the presence of alkaline material, if any, the compositions herein would remain acidic compositions.

The compositions herein may have a water-like viscosity. By “water-like viscosity” it is meant herein a viscosity that is close to that of water. Preferably the liquid acidic hard surface cleaning compositions herein have a viscosity of up to 50 cps at 60 rpm, more preferably from 0 cps to 30 cps, yet more preferably from 0 cps to 20 cps and most preferably from 0 cps to 10 cps at 60 rpm¹ and 20° C. when measured with a Brookfield digital viscometer model DV II, with spindle 2.

In other embodiments, the compositions herein are thickened compositions. Thus, the liquid acidic hard surface cleaning compositions herein preferably have a viscosity of from 50 cps to 5000 cps at 20 s⁻¹, more preferably from 50 cps to 2000 cps, yet more preferably from 50 cps to 1000 cps and most preferably from 50 cps to 500 cps at 20 s⁻¹ and 20° C. when measured with a Rheometer, model AR 1000 (Supplied by TA Instruments) with a 4 cm conic spindle in stainless steal, 2° angle (linear increment from 0.1 to 100 sec⁻¹ in max. 8 minutes). Preferably, the thickened compositions according to this specific embodiment are shear-thinning compositions. The thickened liquid acidic hard surface cleaning compositions herein preferably comprise a thickener, more preferably a polysaccharide polymer (as described herein below) as thickener, still more preferably a gum-type polysaccharide polymer thickener and most preferably Xanthan gum.

The Copolymer:

The hard surface cleaning composition of the invention preferably comprises from 0.01% to 10%, more preferably from 0.05% to 5%, yet more preferably from 0.1% to 3%, most preferably from 0.15 to 1% by weight of the cleaning composition, of the copolymer.

The copolymer comprises monomers selected from the group comprising monomers of formula (I) (Monomer A) and monomers of formula (IIa-IId) (Monomer B). The copolymer comprises from 60 to 99%, preferably from 70 to 95% and especially from 80 to 90% by weight of at least one monoethylenically unsaturated polyalkylene oxide monomer of the formula (I) (monomer A)

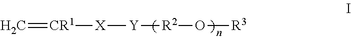

wherein Y of formula (I) is selected from —O— and —NH—; if Y of formula (I) is —O—, X of formula (I) is selected from —CH₂— or —CO—, if Y of formula (I) is —NH—, X of formula (I) is —CO—; R¹ of formula (I) is selected from hydrogen, methyl, and mixtures thereof; R² of formula (I) is independently selected from linear or branched C₂-C₆-alkylene radicals, which may be arranged blockwise or randomly; R³ of formula (I) is selected from hydrogen, C₁-C₄-alkyl, and mixtures thereof; n of formula (I) is an integer from 5 to 100, preferably from 10 to 70 and more preferably from 20 to 50.

The copolymer comprises from 1 to 40%, preferably from 2 to 30% and especially from 5 to 20% by weight of at least one quaternized nitrogen-containing monoethylenically unsaturated monomer of formula (IIa-IId) (monomer B).

The monomers are selected such that the copolymer has a weight average molecular weight (M_{w}) of from 20,000 to 500,000 g/mol, preferably from greater than 25,000 to 150,000 g/mol and especially from 30,000 to 80,000 g/mol.

The copolymer preferably has a net positive charge at a pH of 5 or above.

The copolymer for use in the present invention may further comprise monomers C and/or D.

Monomer C may comprise from 0% to 15%, preferably from 0 to 10% and especially from 1 to 7% by weight of the copolymer of an anionic monoethylenically unsaturated monomer.

Monomer D may comprise from 0% to 40%, preferably from 1 to 30% and especially from 5 to 20% by weight of the copolymer of other non-ionic monoethylenically unsaturated monomers.

Preferred copolymers according to the invention comprise, as copolymerized Monomer A, monoethylenically unsaturated polyalkylene oxide monomers of formula (I) in which Y of formula (I) is —O—; X of formula (I) is —CO—; R¹ of formula (I) is hydrogen or methyl; R² of formula (I) is independently selected from linear or branched C₂-C₄-alkylene radicals arranged blockwise or randomly, preferably ethylene, 1,2- or 1,3-propylene or mixtures thereof, particularly preferably ethylene; R³ of formula (I) is methyl; and n is an integer from 20 to 50.

Monomer A

A monomer A for use in the copolymer of the present invention may be, for example:
(a) reaction products of (meth)acrylic acid with polyalkylene glycols which are not terminally capped, terminally capped at one end by alkyl radicals; and
(b) alkenyl ethers of polyalkylene glycols which are not terminally capped or terminally capped at one end by alkyl radicals.

Preferred monomer A is the (meth)acrylates and the allyl ethers, where the acrylates and primarily the methacrylates are particularly preferred. Particularly suitable examples of the monomer A are:
(a) methylpolyethylene glycol (meth)acrylate and (meth)acrylamide, methylpolypropylene glycol (meth)acrylate and (meth)acrylamide, methylpolybutylene glycol (meth)acrylate and (meth)acrylamide, methylpoly(propylene oxide-co-ethylene oxide) (meth)acrylate and (meth)acrylamide, ethylpolyethylene glycol (meth)acrylate and (meth)acrylamide, ethylpolypropylene glycol (meth)acrylate and (meth)acrylamide, ethylpolybutylene glycol (meth)acrylate and (meth)acrylamide and ethylpoly(propylene oxide-co-ethylene oxide) (meth)acrylate and (meth)acrylamide, each with 5 to 100, preferably 10 to 70 and particularly preferably 20 to 50, alkylene oxide units, where methylpolyethylene glycol acrylate is preferred and methylpolyethylene glycol methacrylate is particularly preferred;
(b) ethylene glycol allyl ethers and methylethylene glycol allyl ethers, propylene glycol allyl ethers and methylpropylene glycol allyl ethers each with 5 to 100, preferably 10 to 70 and particularly preferably 20 to 50, alkylene oxide units.

The proportion of Monomer A in the copolymer according to the invention is 60% to 99% by weight, preferably 70% to 95%, more preferably from 80% to 90% by weight of the copolymer.

Monomer B

A monomer B that is particularly suitable for the copolymer of the invention includes the quaternization products of 1-vinylimidazoles, of vinylpyridines, of (meth)acrylic esters with amino alcohols, in particular N,N-di-C₁-C₄-alkylamino-C₂-C₆-alcohols, of amino-containing (meth)acrylamides, in particular N,N-di-C₁-C₄-alkyl-amino-C₂-C₆-alkylamides of (meth)acrylic acid, and of diallylalkylamines, in particular diallyl-C₁-C₄-alkylamines

Suitable monomers B have the formula IIa to IId:

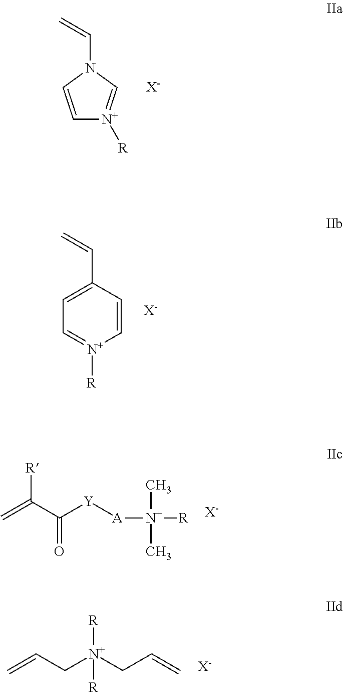

wherein R of formula IIa to IId is selected from C₁-C₄-alkyl or benzyl, preferably methyl, ethyl or benzyl; R′ of formula a is selected from hydrogen or methyl; Y of formula IIc is selected from —O— or —NH—; A of formula IIc is selected from C₁-C₆-alkylene, preferably straight-chain or branched C₂-C₄-alkylene, in particular 1,2-ethylene, 1,3- and 1,2-propylene or 1,4-butylene; X— of formula IIa to IId is selected from halide, such as iodide and preferably chloride or bromide, C₁-C₄-alkyl sulfate, preferably methyl sulfate or ethyl sulfate, C₁-C₄-alkylsulfonate, preferably methylsulfonate or ethylsulfonate, C₁-C₄-alkyl carbonate; and mixtures thereof.

Specific examples of preferred monomer B that may be utilized in the present invention are:
(a) 3-methyl-1-vinylimidazolium chloride, 3-methyl-1-vinylimidazolium methyl sulfate, 3-ethyl-1-vinylimidazolium ethyl sulfate, 3-ethyl-1-vinylimidazolium chloride and 3-benzyl-1-vinylimidazolium chloride;
(b) 1-methyl-4-vinylpyridinium chloride, 1-methyl-4-vinylpyridinium methyl sulfate and 1-benzyl-4-vinylpyridinium chloride;
(c) 3-methacrylamido-N,N,N-trimethylpropan-1-aminium chloride, 3-acryl-N,N,N-trimethylpropan-1-aminium chloride, 3-acryl-N,N,N-trimethylpropan-1-aminium methylsulfate, 3-methacryl-N,N,N-trimethylpropan-1-aminium chloride, 3-methacryl-N,N,N-trimethylpropan-1-aminium methylsulfate, 2-acrylamido-N,N,N-trimethylethan-1-aminium chloride, 2-acryl-N,N,N-trimethylethan-1-aminium chloride, 2-acryl-N,N,N-trimethylethan-1-aminium methyl sulfate, 2-methacryl-N,N,N-trimethylethan-1-aminium chloride, 2-methacryl-N,N,N-trimethylethan-1-aminium methyl sulfate, 2-acryl-N,N-dimethyl-N-ethylethan-1-aminium ethylsulfate, 2-methacryl-N,N-dimethyl-N-ethylethan-1-aminium ethylsulfate, and
(d) dimethyldiallylammonium chloride and diethyldiallylammonium chloride.

A preferred monomer B is selected from 3-methyl- 1-vinylimidazolium chloride, 3-methyl-1-vinylimidazolium methyl sulfate, 3-methacryl-N,N,N-trimethylpropan-1-aminium chloride, 2-methacryl-N,N,N-trimethylethan-1-aminium chloride, 2-methacryl-N,N-dimethyl-N-ethylethan-1-aminium ethylsulfate, and dimethyldiallylammonium chloride.

The copolymer according to the invention comprises 1% to 40% by weight, preferably 2% to 30%, and especially preferable from 5 to 20% by weight of the copolymer, of Monomer B. The weight ratio of Monomer A to Monomer B is preferably equal to or greater than 2:1, preferably 3:1 to 5:1.

Monomer C

As optional components of the copolymer of the present invention, monomers C and D may also be utilized. Monomer C is selected from anionic monoethylenically unsaturated monomers. Suitable monomer C may be selected from:
(a) α,β-unsaturated monocarboxylic acids which preferably have 3 to 6 carbon atoms, such as acrylic acid, methacrylic acid, 2-methylenebutanoic acid, crotonic acid and vinylacetic acid, preference being given to acrylic acid and methacrylic acid;
(b) unsaturated dicarboxylic acids, which preferably have 4 to 6 carbon atoms, such as itaconic acid and maleic acid, anhydrides thereof, such as maleic anhydride;
(c) ethylenically unsaturated sulfonic acids, such as vinylsulfonic acid, acrylamido-propanesulfonic acid, methallylsulfonic acid, methacrylsulfonic acid, m- and p-styrenensulfonic acid, (meth)acrylamidomethanesulfonic acid, (meth)acrylamidoethanesulfonic acid, (meth)acrylamidopropanesulfonic acid, 2-(meth)acrylamido-2-methylpropanesulfonic acid, 2-acrylamido-2-butanesulfonic acid, 3-methacrylamido-2-hydroxypropanesulfonic acid, methanesulfonic acid acrylate, ethanesulfonic acid acrylate, propanesulfonic acid acrylate, allyloxybenzenesulfonic acid, methallyloxybenzenesulfonic acid and 1-allyloxy-2-hydroxypropanesulfonic acid; and
(d) ethylenically unsaturated phosphonic acids, such as vinylphosphonic acid and m- and p-styrenephosphonic acid.

The anionic Monomer C can be present in the form of water soluble free acids or in water-soluble salt form, especially in the form of alkali metal and ammonium, in particular alkylammonium, salts, and preferred salts being the sodium salts.

A preferred Monomer C may be selected from acrylic acid, methacrylic acid, maleic acid, vinylsulfonic acid, 2-(meth)acrylamido-2-methylpropanesulfonic acid and vinylphosphonic acid, particular preference being given to acrylic acid, methacrylic acid and 2-acrylamido-2-methylpropanesulfonic acid.

The proportion of monomer C in the copolymer of the invention can be up to 15% by weight, preferably from 1% to 5% by weight of the copolymer.

If monomer C is present in the copolymer of the present invention, then , the molar ratio of monomer B to monomer C is greater than 1. The weight ratio of Monomer A to monomer C is preferably equal to or greater than 4:1, more preferably equal to or greater than 5:1. Additionally, the weight ratio of monomer B to monomer C is equal or greater than 2:1, and even more preferable from 2.5:1

Monomer D

As an optional component of the copolymer of the present invention, monomer D may also be utilized. Monomer D is selected from nonionic monoethylenically unsaturated monomers selected from:
(a) esters of monoethylenically unsaturated C₃-C₆-carboxylic acids, especially acrylic acid and methacrylic acid, with monohydric C₁-C₂₂-alcohols, in particular C₁-C₁₆-alcohols; and hydroxyalkyl esters of monoethylenically unsaturated C₃-C₆-carboyxlic acids, especially acrylic acid and methacrylic acid, with divalent C₂-C₄-alcohols, such as methyl (meth)acrylate, ethyl (meth)acrylate, n-butyl (meth)acrylate, sec-butyl (meth)acrylate, tert-butyl (meth)acrylate, ethylhexyl (meth)acrylate, decyl (meth)acrylate, lauryl (meth)acrylate, isobornyl (meth)acrylate, cetyl (meth)acrylate, palmityl (meth)acrylate and stearyl (meth)acrylate, hydroxyethyl (meth)acrylate, hydroxypropyl (meth)acrylate and hydroxybutyl (meth)acrylate;
(b) amides of monoethylenically unsaturated C₃-C₆-carboxylic acids, especially acrylic acid and methacrylic acid, with C₁-C₁₂-alkylamines and di(C₁-C₄-alkyl)amines, such as N-methyl(meth)acrylamide, N,N-dimethyl(meth)acrylamide, N-ethyl(meth)acrylamide, N-propyl(meth)acrylamide, N-tert-butyl(meth)acrylamide, N-tert-octyl(meth)acrylamide and N-undecyl(meth)acrylamide, and (meth)acrylamide;
(c) vinyl esters of saturated C₂-C₃₀-carboxylic acids, in particular C₂-C₁₄-carboxylic acids, such as vinyl acetate, vinyl propionate, vinyl butyrate, vinyl 2-ethylhexanoate and vinyl laurate;
(d) vinyl C₁-C₃₀-alkyl ethers, in particular vinyl C₁-C₁₈-alkyl ethers, such as vinyl methyl ether, vinyl ethyl ether, vinyl n-propyl ether, vinyl isopropyl ether, vinyl n-butyl ether, vinyl isobutyl ether, vinyl 2-ethylhexyl ether and vinyl octadecyl ether;
(e) N-vinylamides and N-vinyllactams, such as N-vinylformamide, N-vinyl-N-methyl-formamide, N-vinylacetamide, N-vinyl-N-methylacetamide, N-vinylimidazol, N-vinylpyrrolidone, N-vinylpiperidone and N-vinylcaprolactam;
(f) aliphatic and aromatic olefins, such as ethylene, propylene, C₄-C₂₄-α-olefins, in particular C₄-C₁₆-α-olefins, e.g. butylene, isobutylene, diisobutene, styrene and α-methylstyrene, and also diolefins with an active double bond, e.g. butadiene;
(g) unsaturated nitriles, such as acrylonitrile and methacrylonitrile.

A preferred monomer D is selected from methyl (meth)acrylate, ethyl (meth)acrylate, (meth)acrylamide, vinyl acetate, vinyl propionate, vinyl methyl ether, N-vinylformamide, N-vinylpyrrolidone, N-vinylimidazole and N-vinylcaprolactam. N-vinylimidazol is particularly preferred.

If the monomer D is present in the copolymer of the present invention, then the proportion of monomer D may be up to 40%, preferably from 1% to 30%, more preferably from 5% to 20% by weight of the copolymer.

Preferred copolymers of the present invention include:

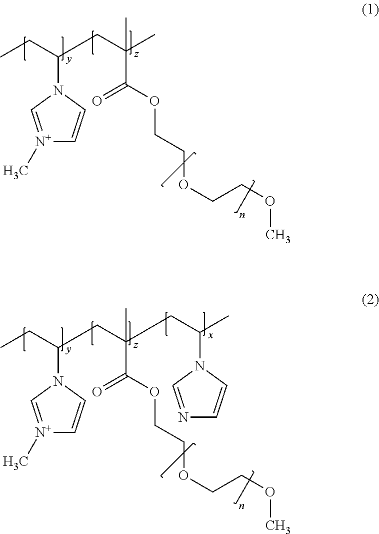

wherein indices y and z are such that the monomer ratio (z:y) is from 3:1 to 20:1 and the inidces x and z are such that the monomer ratio (z:x) is from 1.5:1 to 20:1, and the polymer has a weight average molecular weight of from 20,000 to 500,000 g/mol, preferably from greater than 25,000 to 150,000 g/mol and especially from 30,000 to 80,000 g/mol.

The copolymers according to the invention can be prepared by free-radical polymerization of the Monomers A and B and if desired C and/or D. The free-radical polymerization of the monomers can be carried out in accordance with all known methods, preference being given to the processes of solution polymerization and of emulsion polymerization. Suitable polymerization initiators are compounds which decompose thermally or photochemically (photoinitiators) to form free radicals, such as benzophenone, acetophenone, benzoin ether, benzyl dialkyl ketones and derivatives thereof.

The polymerization initiators are used according to the requirements of the material to be polymerized, usually in amounts of from 0.01% to 15%, preferably 0.5% to 5% by weight based on the monomers to be polymerized, and can be used individually or in combination with one another.

Instead of a quaternized Monomer B, it is also possible to use the corresponding tertiary amines In this case, the quaternization is carried out after the polymerization by reacting the resulting copolymer with alkylating agents, such as alkyl halides, dialkyl sulfates and dialkyl carbonates, or benzyl halides, such as benzyl chloride. Examples of suitable alkylating agents which may be mentioned are, methyl chloride, bromide and iodide, ethyl chloride and bromide, dimethyl sulfate, diethyl sulfate, dimethyl carbonate and diethyl carbonate.

The anionic monomer C can be used in the polymerization either in the form of the free acids or in a form partially or completely neutralized with bases. Specific examples that may be listed are: sodium hydroxide solution, potassium hydroxide solution, sodium carbonate, sodium hydrogen carbonate, ethanolamine, diethanolamine and triethanolamine

To limit the molar masses of the copolymers according to the invention, customary regulators can be added during the polymerization, e.g. mercapto compounds, such as mercaptoethanol, thioglycolic acid and sodium disulfite. Suitable amounts of regulator are 0.1% to 5% by weight based on the monomers to be polymerized.

Optional Ingredients

The compositions according to the present invention may comprise a variety of optional ingredients depending on the technical benefit aimed for and the surface treated.

Suitable optional ingredients for use herein include other acids, preferably acetic acid and/or lactic acid and/or citric acid, chelating agents, nonionic surfactants, vinylpyrrolidone homopolymer or copolymer, polysaccharide polymer, radical scavengers, perfumes, solvents, other surfactants, builders, buffers, bactericides, hydrotropes, colorants, stabilizers, bleaches, bleach activators, suds controlling agents like fatty acids, enzymes, soil suspenders, brighteners, anti dusting agents, dispersants, pigments, and dyes.

Nonionic Surfactant

The compositions of the present invention preferably comprise a nonionic surfactant, or a mixture thereof. This class of surfactants may be desired as it further contributes to cleaning performance of the hard surface cleaning compositions herein. It has been found in particular that nonionic surfactants strongly contribute in achieving highly improved performance on greasy soap scum removal.

The compositions according to the present invention may comprise up to 15% by weight of the total composition of a nonionic surfactant or a mixture thereof, preferably from 0.1% to 10%, more preferably from 0.5% to 5%, even more preferably from 1.0% to 3% by weight of the total composition.

Suitable nonionic surfactants for use herein are alkoxylated alcohol nonionic surfactants, which can be readily made by condensation processes which are well-known in the art. However, a great variety of such alkoxylated alcohols, especially ethoxylated and/or propoxylated alcohols, is conveniently commercially available. Surfactants catalogs are available which list a number of surfactants, including nonionics.

Accordingly, preferred alkoxylated alcohols for use herein are nonionic surfactants according to the formula RO(E)e(P)pH where R is a hydrocarbon chain of from 2 to 24 carbon atoms, E is ethylene oxide and P is propylene oxide, and e and p which represent the average degree of, respectively ethoxylation and propoxylation, are of from 0 to 24 (with the sum of e+p being at least 1). Preferably, the hydrophobic moiety of the nonionic compound can be a primary or secondary, straight or branched alcohol having from 8 to 24 carbon atoms.

Preferred nonionic surfactants for use in the compositions according to the invention are the condensation product of ethylene and/or propylene oxide with an alcohol having a straight alkyl chain comprising from 6 to 22 carbon atoms, wherein the degree of ethoxylation/propoxylation is from 1 to 15, preferably from 5 to 12 or mixtures thereof. Such suitable nonionic surfactants are commercially available from Shell, for instance, under the trade name Neodol® or from BASF under the trade name Lutensol®.

Anionic Polymeric Thickeners

Surprisingly, anionic polymeric thickeners can be used to achieve the desired composition viscosity, even though the copolymers comprise cationic monomeric units (monomer B).

Preferred anionic polymeric thickeners are polysaccharide polymers. As such, the compositions of the present invention may optionally comprise a polysaccharide polymer or a mixture thereof. Typically, the compositions of the present invention may comprise from 0.01% to 5% by weight of the total composition of a polysaccharide polymer or a mixture thereof, more preferably from 0.05% to 3% and most preferably from 0.05% to 1%.

Suitable polysaccharide polymers for use herein include substituted cellulose materials like carboxymethylcellulose, ethyl cellulose, hydroxyethyl cellulose, hydroxypropyl cellulose, hydroxymethyl cellulose, succinoglycan and naturally occurring polysaccharide polymers like Xanthan gum, gellan gum, guar gum, locust bean gum, tragacanth gum or derivatives thereof, or mixtures thereof.

In a preferred embodiment according to the present invention the compositions of the present invention comprise a polysaccharide polymer selected from the group consisting of: carboxymethylcellulose, ethyl cellulose, hydroxyethyl cellulose, hydroxypropyl cellulose, hydroxymethyl cellulose, succinoglycan gum, xanthan gum, gellan gum, guar gum, locust bean gum, tragacanth gum, derivatives of the aforementioned, and mixtures thereof. Preferably, the compositions herein comprise a polysaccharide polymer selected from the group consisting of: succinoglycan gum, xanthan gum, gellan gum, guar gum, locust bean gum, tragacanth gum, derivatives of the aforementioned, and mixtures thereof. More preferably, the compositions herein comprise a polysaccharide polymer selected from the group consisting of: xanthan gum, gellan gum, guar gum, derivatives of the aforementioned, and mixtures thereof. Most preferably, the compositions herein comprise xanthan gum, derivatives thereof, or mixtures thereof.

Particularly polysaccharide polymers for use herein are xanthan gum and derivatives thereof. xanthan gum and derivatives thereof may be commercially available for instance from CP Kelco under the trade name Keltrol RD®, Kelzan S® or Kelzan T®. Other suitable xanthan gums are commercially available by Rhodia under the trade name Rhodopol T® and Rhodigel X747®. Succinoglycan gum for use herein is commercially available by Rhodia under the trade name Rheozan®.

It has been surprisingly found that composition comprising the copolymers described herein, when added into an aqueous acidic composition deliver faster drying when treating a surface as well as improving the stability of the compositions, while delivering good first-time hard-surface cleaning performance and good limescale removal performance.

The composition of the invention may comprise additional cleaning ingredients.

Vinylpyrrolidone Homopolymer or Copolymer

In order to provide improved shine over a wider range of surfaces, the compositions of the present invention may comprise a vinylpyrrolidone homopolymer or copolymer, or a mixture thereof. Typically, the compositions of the present invention may comprise from 0.01% to 5% by weight of the total composition of a vinylpyrrolidone homopolymer or copolymer, or a mixture thereof, more preferably from 0.05% to 3% and most preferably from 0.05% to 1%.

Suitable vinylpyrrolidone homopolymers for use herein are homopolymers of N-vinylpyrrolidone having the following repeating monomer:

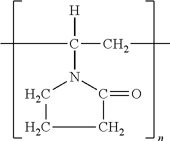

wherein n (degree of polymerisation) is an integer of from 10 to 1,000,000, preferably from 20 to 100,000, and more preferably from 20 to 10,000.

Accordingly, suitable vinylpyrrolidone homopolymers (“PVP”) for use herein have an average molecular weight of from 1,000 to 100,000,000, preferably from 2,000 to 10,000,000, more preferably from 5,000 to 1,000,000, and most preferably from 50,000 to 500,000.

Suitable vinylpyrrolidone homopolymers are commercially available from ISP Corporation, New York, N.Y. and Montreal, Canada under the product names PVP K-15® (viscosity molecular weight of 10,000), PVP K-30® (average molecular weight of 40,000), PVP K-60® (average molecular weight of 160,000), and PVP K-90® (average molecular weight of 360,000). Other suitable vinylpyrrolidone homopolymers which are commercially available from BASF Cooperation include Sokalan HP 165®, Sokalan HP 12®, Luviskol K30®, Luviskol K60®, Luviskol K80®, Luviskol K90®; vinylpyrrolidone homopolymers known to persons skilled in the detergent field (see for example EP-A-262,897 and EP-A-256,696).

Suitable copolymers of vinylpyrrolidone for use herein include copolymers of N-vinylpyrrolidone and alkylenically unsaturated monomers or mixtures thereof.

The alkylenically unsaturated monomers of the copolymers herein include unsaturated dicarboxylic acids such as maleic acid, chloromaleic acid, fumaric acid, itaconic acid, citraconic acid, phenylmaleic acid, aconitic acid, acrylic acid, N-vinylimidazole and vinyl acetate. Any of the anhydrides of the unsaturated acids may be employed, for example acrylate, methacrylate. Aromatic monomers like styrene, sulphonated styrene, alpha-methyl styrene, vinyl toluene, t-butyl styrene and similar well known monomers may be used.

For example particularly suitable N-vinylimidazole N-vinylpyrrolidone polymers for use herein have an average molecular weight range from 5,000 to 1,000,000, preferably from 5,000 to 500,000, and more preferably from 10,000 to 200,000. The average molecular weight range was determined by light scattering as described in Barth H. G. and Mays J. W. Chemical Analysis Vol 113,“Modern Methods of Polymer Characterization”.

Such copolymers of N-vinylpyrrolidone and alkylenically unsaturated monomers like PVP/vinyl acetate copolymers are commercially available under the trade name Luviskol® series from BASF.

According to a very preferred execution of the present invention, vinylpyrrolidone homopolymers are advantageously selected.

Chelating Agent

The compositions of the present invention may comprise a chelating agent or mixtures thereof, as a preferred optional ingredient. Chelating agents can be incorporated in the compositions herein in amounts ranging from 0% to 10% by weight of the total composition, preferably 0.01% to 5.0%, more preferably 0.05% to 1%.

Suitable phosphonate chelating agents to be used herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities.

Preferred chelating agents to be used herein are diethylene triamine penta methylene phosphonate (DTPMP) and ethane 1-hydroxy diphosphonate (HEDP). In a particularly preferred execution of the present invention, the chelating agent is selected to be ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy -3,5-disulfobenzene. A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4, 704, 233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include tetra sodium glutamate diacetate (GLDA), ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® methyl glycine di-acetic acid (MGDA), tetra sodium glutamate diacetate (GLDA) which is, for instance, commercially available from AkzoNobel under the trade name Dissolvine® GL.

Further carboxylate chelating agents to be used herein include salicylic acid, aspartic acid, glutamic acid, glycine, malonic acid or mixtures thereof.

The addition of a chelating agent, preferably HEDP, in the composition of the present invention provides an unexpected improvement in terms of limescale removal.

Solvent

The compositions of the present invention may further comprise a solvent or a mixture thereof, as an optional ingredient. Solvents to be used herein include all those known to those skilled in the art of hard-surfaces cleaner compositions. In a highly preferred embodiment, the compositions herein comprise an alkoxylated glycol ether (such as n-Butoxy Propoxy Propanol (n-BPP)) or a mixture thereof.

Typically, the compositions of the present invention may comprise from 0.1% to 5% by weight of the total composition of a solvent or mixtures thereof, preferably from 0.5% to 5% by weight of the total composition and more preferably from 1% to 3% by weight of the total composition.

Additional Surfactant

The compositions of the present invention may comprise an additional surfactant, or mixtures thereof, on top of the nonionic surfactant already described herein. Additional surfactants may be desired herein as they further contribute to the cleaning performance and/or shine benefit of the compositions of the present invention. Surfactants to be used herein include anionic surfactants, cationic surfactants, amphoteric surfactants, zwitterionic surfactants, and mixtures thereof. Accordingly, the compositions according to the present invention may comprise up to 15% by weight of the total composition of another surfactant or a mixture thereof, on top of the nonionic surfactant already described herein, more preferably from 0.5% to 5%, even more preferably from 0.5% to 3%, and most preferably from 0.5% to 2%. Different surfactants may be used in the present invention including anionic, cationic, zwitterionic or amphoteric surfactants. It is also possible to use mixtures of such surfactants without departing from the spirit of the present invention.

Preferred surfactants for use herein are anionic and zwitterionic surfactants since they provide excellent grease soap scum cleaning ability to the compositions of the present invention.

Anionic surfactants may be included herein as they contribute to the cleaning benefits of the hard-surface cleaning compositions of the present invention. Indeed, the presence of an anionic surfactant contributes to the greasy soap scum cleaning of the compositions herein. More generally, the presence of an anionic surfactant in the liquid acidic compositions according to the present invention allows to lower the surface tension and to improve the wettability of the surfaces being treated with the liquid acidic compositions of the present invention. Furthermore, the anionic surfactant, or a mixture thereof, helps to solubilize the soils in the compositions of the present invention.

Suitable anionic surfactants for use herein are all those commonly known by those skilled in the art. Preferably, the anionic surfactants for use herein include alkyl sulphonates, alkyl aryl sulphonates, or mixtures thereof.

Particularly suitable linear alkyl sulphonates include C8 sulphonate like Witconate® NAS 8 commercially available from Witco.

Other anionic surfactants useful herein include salts (including, for example, sodium, potassium, ammonium, and substituted ammonium salts such as mono-, di- and triethanolamine salts) of soap, alkyl sulphates, alkyl aryl sulphates alkyl alkoxylated sulphates, C8-C24 olefinsulfonates, sulphonated polycarboxylic acids prepared by sulphonation of the pyrolyzed product of alkaline earth metal citrates, e.g., as described in British patent specification No. 1,082,179; alkyl ester sulfonates such as C14-16 methyl ester sulfonates; acyl glycerol sulfonates, alkyl phosphates, isethionates such as the acyl isethionates, N-acyl taurates, alkyl succinamates, acyl sarcosinates, sulfates of alkylpolysaccharides such as the sulfates of alkylpolyglucoside (the nonionic nonsulfated compounds being described below), alkyl polyethoxy carboxylates such as those of the formula RO(CH2CH2O)kCH2COO-M+ wherein R is a C8-C22 alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

Suitable zwitterionic surfactants for use herein contain both basic and acidic groups which form an inner salt giving both cationic and anionic hydrophilic groups on the same molecule at a relatively wide range of pH's. The typical cationic group is a quaternary ammonium group, although other positively charged groups like phosphonium, imidazolium and sulfonium groups can be used. The typical anionic hydrophilic groups are carboxylates and sulfonates, although other groups like sulfates, phosphonates, and the like can be used.

Some common examples of zwitterionic surfactants (i.e. betaine/sulphobetaine) are described in U.S. Pat. Nos. 2,082,275, 2,702,279 and 2,255,082.

For example Coconut dimethyl betaine is commercially available from Seppic under the trade name of Amonyl 265®. Lauryl betaine is commercially available from Albright & Wilson under the trade name Empigen BB/L®. A further example of betaine is Lauryl-immino-dipropionate commercially available from Rhodia under the trade name Mirataine H2C-HA®.

Particularly preferred zwitterionic surfactants for use in the compositions of the present invention are the sulfobetaine surfactants as they deliver optimum soap scum cleaning benefits.

Examples of particularly suitable sulfobetaine surfactants include tallow bis(hydroxyethyl) sulphobetaine, cocoamido propyl hydroxy sulphobetaines which are commercially available from Rhodia and Witco, under the trade name of Mirataine CBS® and Rewoteric AM CAS 15® respectively.

Amphoteric and ampholytic detergents which can be either cationic or anionic depending upon the pH of the system are represented by detergents such as dodecylbeta-alanine, N-alkyltaurines such as the one prepared by reacting dodecylamine with sodium isethionate according to the teaching of U.S. Pat. No. 2,658,072, N-higher alkylaspartic acids such as those produced according to the teaching of U.S. Pat. No. 2,438,091, and the products sold under the trade name “Miranol”, and described in U.S. Pat. No. 2,528,378. Additional synthetic detergents and listings of their commercial sources can be found in McCutcheon's Detergents and Emulsifiers, North American Ed. 1980.

Suitable amphoteric surfactants include the amine oxides. Examples of amine oxides for use herein are for instance coconut dimethyl amine oxides, C12-C16 dimethyl amine oxides. Said amine oxides may be commercially available from Clariant, Stepan, and AKZO (under the trade name Aromox®). Other suitable amphoteric surfactants for the purpose of the invention are the phosphine or sulfoxide surfactants.

Cationic surfactants suitable for use in compositions of the present invention are those having a long-chain hydrocarbyl group. Examples of such cationic surfactants include the quaternary ammonium surfactants such as alkyldimethylammonium halogenides. Other cationic surfactants useful herein are also described in U.S. Pat. No. 4,228,044, Cambre, issued Oct. 14, 1980.

The Process of Cleaning a Hard-Surface or an Object

The copolymers, described herein, can be used in an acidic composition for reducing drying time on a hard surface while improving the shine and phase stability of the composition.

The present invention further encompasses a process of cleaning a hard surface or an object, preferably removing limescale from said hard-surface or said object with a reduced drying time. The process according to the present invention comprises the steps of: applying the liquid acidic hard surface cleaning composition onto said hard-surface or said object; leaving said composition on said hard-surface or said object to act; optionally wiping said hard-surface or object and/or providing mechanical agitation, and then rinsing said hard-surface or said object.

By “hard-surface”, it is meant herein any kind of surfaces typically found in and around houses like bathrooms, kitchens, basements and garages, e.g., floors, walls, tiles, windows, sinks, showers, shower plastified curtains, wash basins, WCs, dishes, fixtures and fittings and the like made of different materials like ceramic, enamel, painted and un-painted concrete, plaster, bricks, vinyl, no-wax vinyl, linoleum, melamine, Formica®, glass, any plastics, metals, chromed surface and the like. The term surfaces as used herein also include household appliances including, but not limited to, washing machines, automatic dryers, refrigerators, freezers, ovens, microwave ovens, dishwashers and so on. Preferred hard surfaces cleaned with the liquid aqueous acidic hard surface cleaning composition herein are those located in a bathroom, in a toilet or in a kitchen, basements, garages as well as outdoor such as garden furniture, gardening equipments, driveways etc.

The objects herein are objects that are subjected to limescale formation thereon. Such objects may be water-taps or parts thereof, water-valves, metal objects, objects made of stainless-steel, cutlery and the like.

The copolymers described herein are particularly useful in acidic cleaning compositions for providing a reduced drying time on surfaces, while also not affecting limescale removal.

The preferred process of cleaning a hard-surface or an object (preferably removing limescale from said hard-surface or said object) comprises the step of applying a composition according to the present invention onto said hard-surface or object, leaving said composition on said hard-surface or object to act, preferably for an effective amount of time, more preferably for a period comprised between 10 seconds and 10 minutes, most preferably for a period comprised between 15 seconds and 4 minutes; optionally wiping said hard-surface or object with an appropriate instrument, e.g. a sponge; and then preferably rinsing said surface with water.

Even though said hard-surface or object may optionally be wiped and/or agitated during the process herein, it has been surprisingly found that the process of the present invention allows good limescale removal performance without any additional mechanical wiping and/or agitation action. The lack of need for additional wiping and/or mechanical; agitation provides an added convenience for the user of the compositions herein.

The compositions of the present invention may be contacted to the surface or the object to be treated in its neat form or in its diluted form. Preferably, the composition is applied in its neat form.

By “diluted form”, it is meant herein that said composition is diluted by the user, typically with water. The composition is diluted prior use to a typical dilution level of 10 to 400 times its weight of water, preferably from 10 to 200 and more preferably from 10 to 100. Usual recommended dilution level is a 1.2% dilution of the composition in water.

The compositions according to the present invention are particularly suitable for treating hard-surfaces located in and around the house, such as in bathrooms, toilets, garages, on driveways, basements, gardens, kitchens, etc., and preferably in bathrooms. It is however known that such surfaces (especially bathroom surfaces) may be soiled by the so-called “limescale-containing soils”. By “limescale-containing soils” it is meant herein any soil which contains not only limescale mineral deposits, such as calcium and/or magnesium carbonate, but also soap scum (e.g., calcium stearate) and other grease (e.g. body grease). By “limescale deposits” it is mean herein any pure limescale soil, i.e., any soil or stains composed essentially of mineral deposits, such as calcium and/or magnesium carbonate.

The compositions herein may be packaged in any suitable container, such as bottles, preferably plastic bottles, optionally equipped with an electrical or manual trigger spray-head.

Polymer Synthesis

GPC(SEC) Method to determine the molecular weight of the copolymer:

The weight average molecular weight of the polymers are determined by the technique of Size Exclusion Chromatography (SEC). SEC separation conditions were three hydrophilic Vinylpolymer network gel columns, in distilled water ion the presence of 0,1% (w/w) trifluoroacetic acid/0,1 M NaCl at 35° C. Calibration was done with narrowly distributed Poly(2-vinylpyridine)-standard of company PSS, Deutschland with molecular weights Mw=620 to M=2.070.000.

Example polymer according to the invention: MPEG-EO units/Vinyl imidazole/Methyl-vinyl-imidazolium, 80/15/5wt %.

In a 2 L stirred vessel, water (199 g) was charged and heated to 85° C. under a flow of nitrogen. A solution of Wako V50 (3 g, Wako Pure Chemical Industries, Ltd.) in water (47 g) is added over 4 h, a solution of Methoxypolyethylenglycol methacrylate with molecular weight˜1000 g/mol (50%, 484,8 g, Bisiomer S10W, GEO Specialty Chemicals) and 3-Methyl-1-vinyl-1H-imidazolium-methyl-sulfat (45%, 33,3 g, BASF SE), and 1-vinylimidazole (45 g) and water (177,6 g) over 3 hours. The polymerization mixture is kept at this temperature for additional 30 min after the three streams have finished. Subsequently a solution of Wako V50 (1,5 g) in water (23,5 g) is added at once and the reaction stirred for 2 h. Afterwards the reaction cooled down to room temperature. The GPC measured following above method gives values of Mw=60,300 g/mol.

Methods:

A) pH Measurement:

The pH is measured on the neat composition, at 25° C., using a Sartarius PT-10P pH meter with gel-filled probe (such as the Toledo probe, part number 52 000 100), calibrated according to the instructions manual.

### EXAMPLE 1

These following compositions were made comprising the listed ingredients in the listed proportions (active weight %). The examples herein are met to exemplify the present invention but are not necessarily used to limit or otherwise define the scope of the present invention.

To illustrate the shorter drying times obtained with the compositions of the invention, the protocol below was followed. Two compositions were prepared, compositions A according to the invention and composition B as a reference composition outside the scope of the invention. The values are reported as percent of active raw material.

| | Composition | |
|---|---|---|
| | A | |
| | According to the | B |
| | invention | Reference composition |
| | % of active raw material | |
| Water | Balance up to 100 | Balance up to 100 |
| Citric acid | 4.20 | 4.20 |
| Formic acid | 2.70 | 2.70 |
| Nonionic surfactant ¹ | 2.20 | 2.20 |
| Sodium Hydroxide | 0.50 | 0.50 |
| Xantham gum | 0.30 | 0.30 |
| Perfume | 0.24 | 0.24 |
| Aesthetic dye | 0.10 | 0.10 |
| Polyvinylpyrrolidone | — | 0.025 |
| Polymer A ² | 0.025 | — |
| pH | 1.98 | 1.98 |

¹ Non-ionic surfactant is C9-C11 8EO, sourced as Neodol ® 91-8 from Shell.
² Polymer A is MPEG-25EO/QVI/VI with a 80/5/15 percent weight and 60,300 g/mol

The drying test is done on a standard test surface, which is a black glossy tile (Sphinx Highlight Black, 20 cm×20 cm, available from Carobati Boomsesteenweg 36, 2630 Aartselaar, Blegium). The black tiles are washed with an all-purpose cleaner, not containing any polymer (Mr. Propre APC, commercially available) and thoroughly rinse with tap water until they are completely free of any residue. The tiles are then dried with a paper towel. The tiles are then placed vertically (with a slight inclination of up to 5 degrees) resting on a suitable support.

With a plastic disposable pipette, 3 mL of the solution are then applied at the top of the tile with a swift motion from the top left to the top right corner. The product is then immediately spread evenly across the surface of the tile, with at least four vertical strokes followed by four horizontal strokes using a cellulose sponge. (The sponges have been washed at 95 C three times in a domestic washing machine, without any detergent, prior to the experiment). The product is allowed to remain on the surface for 15 seconds.

Once this time has passed, the tiles are then thoroughly rinsed for 30 seconds using a showerhead with a water flow of 4 L/min. The tiles are then allowed to dry, measuring the time it takes for the water to evaporate. Once the tiles are dry the shine of the tiles washed with the composition of the invention is compared to the shine of the tile washed with the reference composition. A visual grading system is used, going from 0 to 5, where 0 means perfect sparkling and clear surface and 5 means cloudy surface with visible streaks and water marks. The tiles are dried in a controlled temperature and humidity room at 20° C. and a relative humidity of 40%. The procedure is repeated twice and the average values reported.

| | | Shine visual grades |
|---|---|---|
| Testing product | Water Drying time (sec) | (absolute) |
| Composition B | 130 | 4 |
| Composition A | 11 | 1.4 |

From this example is possible to see that the composition containing the copolymer of the present invention has a shorter drying time and an improved shine after rinsing the product from the tile.

### EXAMPLE 2

The following five compositions were prepared to illustrate the benefits of the invention. Compositions C, D, E and F contain a copolymer as defined by the present invention, while composition G is outside of the scope of the invention and is used a comparative example.

| | Composition | | | | |
|---|---|---|---|---|---|
| | | | | | G |
| | C | D | E | F | Reference |
| | According to the invention | | | | composition |
| Ingredient | % of active raw material | | | | |
| Water | Balance | Balance | Balance | Balance | Balance |
| | up | up | up | up | up |
| | to 100 | to 100 | to 100 | to 100 | to 100 |
| Formic acid | 2.70 | 2.70 | 2.70 | 2.70 | 2.70 |
| Nonionic | 2.20 | 2.20 | 2.20 | 2.20 | 2.20 |
| surfactant ¹ | | | | | |
| Citric acid | 1.70 | 1.70 | 1.70 | 1.70 | 1.70 |
| Sodium | 0.50 | 0.50 | 0.50 | 0.50 | 0.50 |
| Hydroxide | | | | | |
| Xantham gum | 0.30 | 0.30 | 0.30 | 0.30 | 0.30 |
| Polyvinyl- | — | — | — | — | 0.025 |
| pyrrolidone | | | | | |
| Polymer A ² | 0.025 | — | — | — | — |
| Polymer B ³ | — | 0.025 | — | — | — |
| Polymer C ⁴ | — | — | 0.025 | — | — |
| Polymer D ⁵ | — | — | — | 0.025 | — |
| pH | 2.2 | 2.2 | 2.2 | 2.2 | 2.2 |

¹ Non-ionic surfactant is C9-C10 EO8, sourced as Marlipal ®.
² Polymer A is MPEG-25EO/QVI/VI with a 80/5/15 percent weight and 60,300 g/mol
³ Polymer B is MPEG-25EO/QVI/VI with a 80/10/10 percent weight and 79,200 g/mol
⁴ Polymer C is MPEG-25EO/QVI with a 80/20 percent weight and 34,100/mol
⁵ Polymer D is MPEG-25EO/QVI/VI with a 90/5/5 percent weight and 52,425 g/mol

Following the methodology described above the following drying times and shine grades where recorded.

| | | Shine visual grades |
|---|---|---|
| Testing product | Water Drying time (sec) | (absolute) |
| Composition G | 115 | 2.5 |
| Composition F | 9 | 2.75 |
| Composition E | 13 | 2.25 |
| Composition D | 13 | 1.38 |
| Composition C | 26 | 1.75 |

As in the previous example, compositions containing the copolymer of the inventions exhibit a faster drying after once rinse once the product is applied to the surface.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid acidic hard surface cleaning composition having a pH of from about 0.1 to about 6.5 and comprising a copolymer, wherein the copolymer comprises:
i. from about 60 to about 99% by weight of at least one monoethylenically unsaturated polyalkylene oxide monomer of the formula I (monomer A) 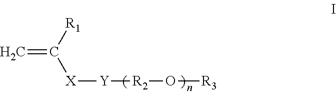
in which the variables have the following meanings:
X is —CH₂— or —CO—, if Y is —0—;
is —CO—, if Y is —NH—;
Y is —O— or —NH—;
R₁ is hydrogen or methyl;
R₂ are identical or different C2-C6-alkylene radicals;
R₃ is H or C1-C4 alkyl;
n is an integer from about 5 to about 100,
ii. from about 1 to about 40% by weight of at least one quaternized nitrogen-containing monomer, selected from the group consisting of at least one of the monomers of the formula IIa to IId (monomer B) 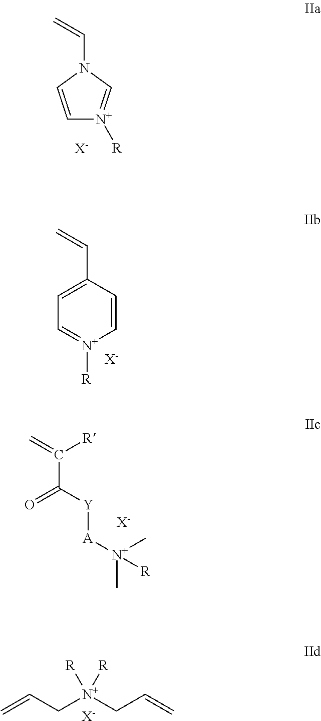
in which the variables have the following meanings:
R is C1-C4 alkyl or benzyl;
R′ is hydrogen or methyl;
Y is —O— or —NH—;
A is C1-C6 alkylene;
X⁻ is halide, C1-C4-alkyl sulfate, C1-C4-alkylsulfonate and C1-C4-alkyl carbonate,
iii. from about 0 to about 15% by weight of at least one anionic monoethylenically unsaturated monomer (monomer C), and
iv. from about 0 to about 30% by weight of at least one other non-ionic monoethylenically unsaturated monomer (monomer D), wherein:
if monomer C is present, the molar ratio of monomer B to monomer C is greater than about 1, and
the copolymer has a weight average molecular weight (Mw) from about 20,000 g/mol to about 500,000 g/mol.

2. The composition according to claim 1, in which the variables of monomer (A) have the following meanings:
X is —CO—;
Y is —O—;
R₁ is hydrogen or methyl;
R₂ is ethylene, linear or branched propylene or mixtures thereof;
R₃ is methyl;
n is an integer from about 5 to about 100.

3. The hard surface composition according to claim 2, wherein monomer A of the copolymer, n is an integer from about 20 to about 50.

4. The hard surface cleaning composition according to claim 1, wherein the copolymer comprises from about 60 to about 99% by weight of monomer A and from about 1 to about 20% by weight of monomer B, from about 0 to about 15% by weight of monomer C, and from about 0 to about 20% by weight of monomer D, and where monomer C is present, the weight ratio of monomer B to monomer C is greater than about 1.

5. The hard surface cleaning composition according to claim 4, wherein the weight ratio of monomer B to monomer C of the copolymer is greater than about 2.5.

6. The composition according to claim 1, wherein monomer (B) is a salt of 3-methyl-1-vinylimidazolium.

7. The hard surface cleaning composition according to claim 1 wherein monomer A is methylpolyethylene glycol (meth)acrylate.

8. The hard surface cleaning composition according to claim 1 wherein monomer A is methylpolyethylene glycol (meth)acrylate and wherein monomer B is a salt of 3-methyl-1-vinylimidazolium, and monomer D is N-vinylimidazole.

9. The composition according to claim 1, wherein said composition further comprises an anionic polymeric thickener.

10. The composition according to claim 1, wherein said composition has a pH of from about 1 to about 6.

11. The composition according to claim 1, wherein the composition comprises acid an acid system, the acid system comprising acid selected from the group consisting of: citric acid, formic acid, acetic acid, maleic acid, lactic acid, glycolic acid, succinic acid, glutaric acid, adipic acid, sulphamic acid, sulphuric acid, hydrochloric acid, phosphoric acid, nitric acid, methane sulphonic acid, and mixtures thereof.

12. The composition according to claim 9, wherein said composition comprises the acid system at a level of from about 0.01% to about 15% by weight of the total composition.

13. The composition according to claim 1, wherein said composition further comprises a nonionic surfactant.

14. The composition according to claim 13, wherein the nonionic surfactant is the condensation product of ethylene and/or propylene oxide with an alcohol having a straight alkyl chain comprising from about 6 to about 22 carbon atoms, wherein the degree of ethoxylation/propoxylation is from about 1 to about 15, or mixtures thereof.

15. The composition according to claim 1, wherein said composition further comprises one or more ingredients selected from the group of: vinylpyrrolidone homopolymer or copolymer; polysaccharide polymer; solvents; anionic surfactants; cationic surfactants; amphoteric surfactants; zwitterionic surfactants; radical scavengers; caustics; perfumes; and dyes; and mixtures thereof.

16. The composition according to claim 1, wherein said composition further comprises an alkaline material.

17. The composition according to claim 16, wherein the alkaline material is selected from the group consisting of sodium hydroxide, potassium hydroxide, lithium hydroxide, the alkali metal oxides such as sodium and/or potassium oxide or mixtures thereof, monoethanolamine, triethanolamine, ammonia, ammonium carbonate and, choline base and mixtures thereof.

18. The composition according to claim 17, wherein the alkaline material is selected from the group consisting of sodium hydroxide or potassium hydroxide.

19. A process of removing limescale from a hard surface or an object, comprising the steps of: applying a liquid acidic hard surface cleaning composition according to claim 1 onto said hard-surface or said object; leaving said composition on said hard-surface or said object to act; optionally wiping said hard-surface or object and/or providing mechanical agitation, and then rinsing said hard-surface or said object.

20. A process of removing limescale from an object, comprising the step of immersing said object in a bath comprising a composition according to claim 1, leaving said object in said bath for said composition to act, and then rinsing said object.
